(19) United States
(12) Patent Application Publication
(10) Pub. No.: US 2024/0069405 A1
(43) Pub. Date: Feb. 29, 2024

(54) OPTICAL PHASED ARRAY DEVICE INCLUDING COMPLEMENTARY AMPLIFIER, AND LIDAR DEVICE INCLUDING THE SAME

(71) Applicant: Samsung Electronics Co., Ltd., Suwon-si (KR)

(72) Inventors: Woosung KIM, Suwon-si (KR); Hyunil BYUN, Suwon-si (KR); Dongjae SHIN, Suwon-si (KR)

(73) Assignee: Samsung Electronics Co., Ltd., Suwon-si (KR)

(21) Appl. No.: 18/171,525

(22) Filed: Feb. 20, 2023

(30) Foreign Application Priority Data
Aug. 30, 2022 (KR) 10-2022-0108991

(51) Int. Cl. G02F 1/295; G01S 7/481

(52) U.S. Cl. CPC G02F 1/2955; G01S 7/4817

(57) ABSTRACT

An optical phased array device according to at least one embodiment includes a light distribution unit configured to branch a traveling path of light, input through an input terminal, at least twice, and to direct distributed pieces of sub-light to a plurality of output terminals; at least one light modulator configured to form a plurality of channels by modulating phases of the pieces of sub-light; at least one first amplifier in an optical path between the input terminal and the at least one light modulator, the at least one first amplifier configured to amplify at least a piece of sub-light; at least one first complementary amplifier configured to replace the at least one first amplifier; and a switch configured to switch the first complementary amplifier in or out of the optical path between the input and the at least one light modulator.

### CROSS-REFERENCE TO RELATED APPLICATION

This application is based on and claims priority under 35 U.S.C. § 119 to Korean Patent Application No. 10-2022-0108991, filed on Aug. 30, 2022, in the Korean Intellectual Property Office, the disclosure of which is incorporated by reference herein in its entirety.

### BACKGROUND

### 1. Field

The disclosure relates to an optical phased array (OPA) device including a complementary amplifier, and a light detection and ranging (LiDAR) device including the same.

### 2. Description of the Related Art

Light detection and ranging (LiDAR) technology based on silicon photonics intends to implement non-mechanical beam steering technology. An optical phased array (OPA), which is a representative technology, is technology that distributes light from a light source into a plurality of channels and steers the light of each channel through phase control. In this method, a splitter is mainly used to emit light, but a 32-channel method uses 1×2 splitters of 5 levels. Through this method, because light is distributed from one light source to 32 channels, power of the light reaching each channel is 1/32 the power when losses of an optical waveguide and splitters of a maximum output of the one light source are not taken into account. However, due to the limitation of the power of the silicon photonics light source, power is reduced due to multi-channel dispersion, which is generally supplemented by using a semiconductor optical amplifier (SOA).

### SUMMARY

Provided is an optical phased array device capable of increasing driving probability through complementary amplifiers.

Provided is an optical phased array device including multi-channels, the optical phased array device may be designed, produced, and driven.

Provided is a Light detection and ranging (LiDAR) device including an optical phased array device including multi-channels.

Additional aspects will be set forth in part in the description which follows and, in part, will be apparent from the description, or may be learned by practice of the presented embodiments of the disclosure.

According to an aspect of the disclosure, an optical phased array device includes a light distribution unit including an input terminal and a plurality of output terminals optically connected to the input terminal, the light distribution unit configured to branch a traveling path of light, input through the input terminal, at least twice, and to direct distributed pieces of sub-light to the plurality of output terminals; at least one light modulator configured to form a plurality of channels by modulating phases of the pieces of sub-light; at least one first amplifier in an optical path between the input terminal and the at least one light modulator, the at least one first amplifier configured to amplify at least a piece of sub-light; at least one first complementary amplifier configured to replace the at least one first amplifier; and a switch configured to switch the first complementary amplifier in or out of the optical path between the input and the at least one light modulator.

The light distribution unit may include a plurality of branch points, wherein the at least one first amplifier includes a plurality of first amplifiers such that a first amplifier is disposed in each of a plurality of optical paths between an initial branch point and a final branch point.

The at least one light modulator includes a plurality of light modulators such that a light modulator is disposed in each of a plurality of optical paths between the final branch point and the plurality of output terminals.

The light distribution unit may be configured to branch the light input through the input terminal M times to form 2^{M} number of optical paths.

The number of first amplifiers may be P, and the number of first complementary amplifiers may be Q, wherein the switch may be a P×Q optical switch configured to change an optical path passing through at least one of the first amplifiers to an optical path passing through at least one of the first complementary amplifiers.

The optical phased array device may further include a monitoring photodiode electrically connected to the at least one first amplifier and configured to monitor the performance of the at least one first amplifier.

The monitoring photodiode may be connected in serial or dissected with the at least one first amplifier.

The monitoring photodiode may be configured to include a first operating mode, in which power is through a forward direction voltage, and a second operation mode in which power is measured through a reverse direction voltage.

The monitoring photodiode may have a tapped connection with the at least one first amplifier.

The monitoring photodiode may measure power via a reverse direction voltage only during calibration.

The optical phased array device may further include a monitoring photodiode array for calibrating the at least one light modulator.

The monitoring photodiode array may be configured to monitor all of the plurality of channels.

The optical phased array device may be configured such that the switch replaces the at least one first amplifier with the at least one first complementary amplifier when the performance of the at least one first amplifier is degraded.

The optical phased array device may further include at least one second amplifier in an optical path passing through the at least one light modulator; at least one second complementary amplifier configured to replace the at least one second amplifier; and a second switch configured to switch the at least one second complementary amplifier in and out of the optical path passing through the at least one light modulator.

The optical phased array device may be configured such that the second switch replaces the at least one second amplifier with the at least one second complementary amplified when the performance of the at least one second amplifier is degraded.

The number of second amplifiers may be P′, and the number of second complementary amplifiers is Q′, wherein the second switch may be a P′×Q′ optical switch configured to change an optical path passing through at least one of the P′ number of second amplifiers to an optical path passing through at least one of the Q′ number of second auxiliary amplifiers.

The optical phased array device may further include a monitoring photodiode array for calibrating the light modulator.

The monitoring photodiode array may calibrate a channel adjacent to the replaced second amplifier among a plurality of second amplifiers.

The optical phased array may further include a waveguide-based structure forming an optical connection between the light distribution unit, the at least one first amplifier, the first complementary amplifier, and the switch.

According to another aspect of the disclosure, a light detection and ranging (LiDAR) device includes a light source, a detector, a processor, and a steering unit including an optical phased array device including a light distribution unit including an input terminal and a plurality of output terminals optically connected to the input terminal, the light distribution unit configured to branch a traveling path of light, input through the input terminal, at least twice, and to direct distributed pieces of sub-light to the plurality of output terminals, at least one light modulator configured to form a plurality of channels by modulating phases of the pieces of sub-light, at least one first amplifier in an optical path between the input terminal and the at least one light modulator, the at least one first amplifier configured to amplify at least a piece of sub-light at least one first complementary amplifier configured to replace the at least one first amplifier, and a switch configured to switch the at least one first complementary amplifier in or out of the optical path between the input and the at least one light modulator.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a diagram conceptually illustrating an optical phased array device according to at least one embodiment;

FIG. 2 is a diagram illustrating an optical phased array device according to at least one embodiment;

FIG. 3 is a diagram illustrating an example of a light distribution unit that may be included in an optical phased array device according to at least one embodiment;

FIGS. 4 to 7 are diagrams illustrating a switch according to at least one embodiment;

FIGS. 8 to 10 are diagrams illustrating a connection between a first amplifier and a monitoring photodiode according to at least one embodiment;

FIG. 11 is a timing diagram illustrating a periodic calibration method;

FIG. 12 is a timing diagram illustrating a calibration method based on a signal-to-noise ratio;

FIG. 13 is a diagram illustrating a light detection and ranging (LiDAR) device according to at least one embodiment; and

FIGS. 14 and 15 are example semiconductor systems to which the LiDAR device according to at least one example embodiment can be applied.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. The embodiments are merely described below, by referring to the figures, to explain aspects. As used herein, the term “and/or” includes any and all combinations of one or more of the associated listed items. Expressions such as “at least one of,” when preceding a list of elements, modify the entire list of elements and do not modify the individual elements of the list.

Hereinafter, an optical phased array (OPA) device including a complementary amplifier and a light detection and ranging (LiDAR) device including the same, according to various embodiments will be described in detail with reference to the accompanying drawings.

Hereinafter, when an element or layer is referred to as being “on” or “above” another element or layer, the element or layer may be directly on another element or layer or intervening elements or layers. The singular forms include the plural forms unless the context clearly indicates otherwise. When a part “comprises” or “includes” an element in the specification, unless otherwise defined, it is not excluding other elements but may further include other elements.

The term “above” and similar directional terms may be applied to both singular and plural. It will be understood that the directional terms are intended to encompass different orientations of the device in use or operation in addition to the orientation depicted in the figures. For example, if the device in the figures is otherwise oriented (e.g., rotated 90 degrees or at other orientations), the directional descriptors used herein are to be interpreted accordingly. With respect to operations that constitute a method, the operations may be performed in any appropriate sequence unless the sequence of operations is clearly described and/or unless the context clearly indicates otherwise. The operations may not necessarily be performed in the order of sequence.

Connections or connection members of lines between components shown in the drawings illustrate functional connections and/or physical or circuit connections, and the connections or connection members can be represented by replaceable or additional various functional connections, physical connections, or circuit connections in an actual apparatus. Unless expressly indicated otherwise, functional elements may include or be controlled by processing circuitry such as hardware, software, or a combination thereof configured to perform a specific function. For example, the processing circuitry more specifically may be and/or include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), electrical components (such as at least one of transistors, resistors, capacitors, logic gates (including at least one of AND gates, OR gates, NOR gates, NAND gates, NOT gates, XOR gates, etc.), and/or the like), etc.

All examples or example terms are simply used to explain in detail the technical scope of the inventive concepts, and thus, the scope of the inventive concepts is not limited by the examples or the example terms as long as it is not defined by the claims.

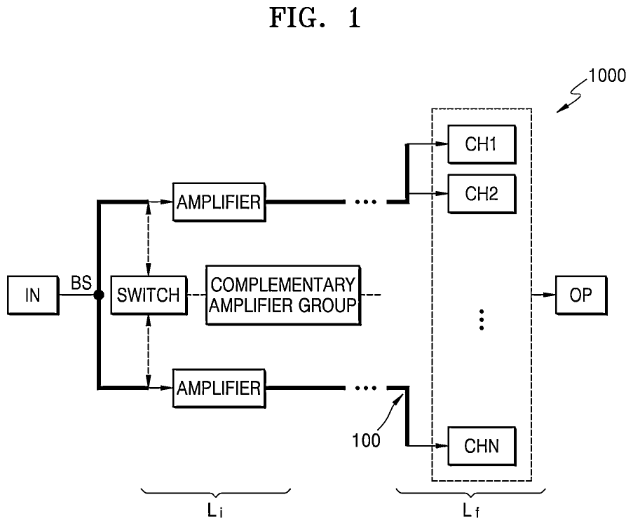

FIG. 1 is a diagram conceptually illustrating an optical phased array device 1000 according to at least one embodiment.

Referring to FIG. 1, the optical phased array device 1000 includes a light distribution unit 100 configured to branch a traveling path of light input through an input terminal and distribute the light into pieces of sub-light for forming a plurality of channels CH1,CH2, . . . ,CHN, and a plurality of amplifiers, arranged in the plurality of paths through which the branched light travels, to amplify the light. In addition, the optical phased array device 1000 includes a complementary amplifier configured to replace any one of the plurality of amplifiers and a switch for switching the complementary amplifier to be included in (or excluded from) an optical path for forming channels by replacing an amplifier with the complementary amplifier.

The light distribution unit 100 may comprise a structure including one or more splitters BS, for example, the one or more splitter BS may be disposed at each branch point. In at least one example embodiment, the splitter BS may be (or include) a beam splitter such as a prism and/or half-mirror (e.g., a dichroic mirror, pellicle mirror, etc.) such that light received from, e.g., a tunable laser diode, is distributed downstream of the splitter BS as sub-pieces of the received light (or pieces of sub-light) based on, e.g., incident angle, wavelength, polarity, and/or the like. The light distribution unit 100 may branch light into a plurality of levels including a first level Lᵢ and a second level L_{f}. In the drawing, the second level L_{f} is the last level after the last branch point, and the first level Lᵢ may be any level between the first branch point and the last branch point. In the drawing, the amplifiers are shown as being disposed in two paths of the first level Lᵢ, which is a position branched once, but this is only an example, and the first level Lᵢ may be a position branched, e.g., twice, three, and/or more (M) times, and the number of amplifiers may be four, eight, and/or 2^{M}. For example, in at least one embodiment, the optical paths may form a binary tree structure, including m levels and 2^{M} optical paths, which may be referred to as a “perfect binary tree structure” of M levels.

When there are P number of amplifiers arranged in P number of optical paths and there are Q number of complementary amplifiers included in a complementary amplifier group, the switch may be P×Q number of light switches. That is, the switch may change an optical path passing through any one of the P number of amplifiers to an optical path passing through any one of the Q number of complementary amplifiers.

Although it is depicted that the complementary amplifier group replaces an amplifier of the first level Lᵢ, another complementary amplifier group configured to replace an amplifier located at a different level may further be provided, and a switch for this replacement may further be provided.

An optical connection between the light distribution unit 100, an amplifier, a complementary amplifier, and a switch may be formed in a waveguide-based structure. In at least one embodiment, a general semiconductor material and/or insulating material may be used as the waveguide. The waveguide may include a rib-type waveguide having one vertical protrusion, a rib-type waveguide having a plurality of vertical protrusions, and/or a channel-type waveguide having no protrusion.

The light distribution unit 100 may branch a traveling path of light input through an input terminal twice (or more) so that distributed pieces of sub-light form a plurality of channels and are directed toward a plurality of output terminals. The light distribution unit 100 includes a plurality of branch points and may distribute input light into pieces of sub-light. The light distribution unit 100 may receive light (or an optical signal) generated from a light source and distribute the light (or optical signal) to a plurality of waveguides. The light distribution unit 100 may distribute light emitted from a single light source into N (N is a natural number) number of channels. The light distribution unit 100 may equally distribute light emitted from a single light source to N channels, but the examples are not limited thereto. For example, the light distribution unit 100 may distribute light emitted from a single light source into N number of channels in different amounts from each other.

A light modulator (not shown) may be disposed in an optical path of the second level L f to modulate the phases of the pieces of sub-light to form a plurality of channels CH1, CH2, . . . , CHN. The light modulator may be, for example disposed in each of the plurality of optical paths between a final branch point and the plurality of output terminals.

An amplifier may be disposed in an optical path between the input terminal and the light modulator to amplify the amount of the pieces of sub-light. For example, the amplifier may receive a current from an external power source and generate amplified light using the energy of the provided current. An amplifier may be disposed in each of a plurality of optical paths formed between the first and last branch points.

In at least one embodiment, the amplifier may be implemented as a Fabry-Perot Amplifier (FPA) type and/or a Traveling Wave Amplifier (TWA) type. In general, a semiconductor optical amplifier may be manufactured in a small size, operates in a wavelength band of 1310 nm and 1150 nm, and is capable of bidirectional transmission, and each of the amplifiers may also have such characteristics. Each of the plurality of amplifiers may amplify light distributed from the light distribution unit 100 with the same gain, but the examples are not limited thereto. Each of the plurality of amplifiers may amplify light distributed from the light distribution unit 100 with different gains.

A complementary amplifier may replace a degraded amplifier. The complementary amplifier may be otherwise identical to an amplifier (e.g., except that the complementary amplifier is configured to replace a degraded amplifier).

The switch may switch the complementary amplifier to be in or out of an optical path towards the light modulator. The switch may be configured to select a complementary amplifier to replace an amplifier when the amplifier degraded. The switch may select any complementary amplifier over any optical path. The switch may include a ring switch, a Mach-Zehnder interferometer (MZI) switch, an opto-mechanical switch, and/or the like.

Light of the plurality of channels CH1, CH2, . . . , CHN may be output through an optical output unit OP. Light of a plurality of channels CH1, CH2, . . . , CHN, which is branched into N number of optical paths by the light distribution unit 100 and a phase, of which is modulated to a determined phase, may form an optical output unit OP by being arrayed at a plurality of output terminals through which the light is to be output. Light is output through the optical output unit OP in a determined direction according to an array shape of the output terminals and the phase of each channel. The optical output unit OP may emit light toward a determined target. If phases of light constituting the plurality of channels CH1, CH2, . . . , CHN are appropriately adjusted through the light modulator, a light output direction of the optical output unit OP may be directed in a required direction.

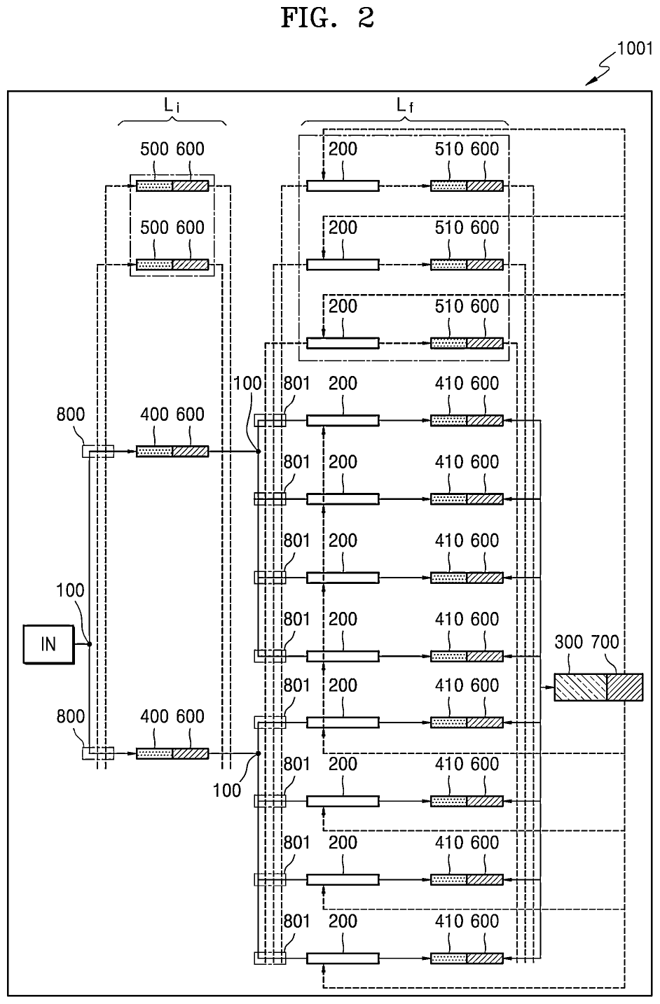

FIG. 2 is a diagram illustrating an optical phased array device 1001 according to at least one embodiment. As shown in FIG. 2, the optical phased array device 1001 may include a light distribution unit 100 configured to branch a traveling path of light input through an input terminal twice or more to direct distributed pieces of sub-light towards a plurality of output terminals, a plurality of light modulators 200 for forming a plurality of channels by modulating the phases of the pieces of sub-light, respectively, an optical output unit 300 for emitting modulated pieces of sub-light as modulated light, a plurality of first amplifiers 400 disposed in optical paths between an input terminal and the light modulators 200 to amplify light, a plurality of first complementary amplifiers 500 that may replace a first amplifier 400, a plurality of monitoring photodiodes 600 electrically connected to the first amplifiers 400 to monitor the performance of the first amplifiers 400, a monitoring photodiode array 700 for calibrating the light modulator 200, and a plurality of switches 800 for switching a first complementary amplifier to be in or out of an optical path toward the light modulator 200.

The light distribution unit 100, the optical output unit 300, the first amplifiers 400, the first complementary amplifiers 500, and the switches 800 may respectively be the same as the light distribution unit 100, the optical output unit OP, the amplifiers, the complementary amplifiers, and the switches of FIG. 1.

The light modulator 200 may be disposed in each channel of a second level L_{f} to modulate phases of pieces of sub-light. The light modulator 200 may be disposed in each of the plurality of optical paths between the final branch point and the plurality of output terminals. The light modulator 200 may modulate a phase of light distributed from the light distribution unit 100 to each waveguide. The light modulator 200 may apply any of, e.g., heat, light, current, voltage, and/or pressure to the waveguide to modulate the phase of light passing through the waveguide.

The optical phased array device 1001 may further include the monitoring photodiode 600. The monitoring photodiode 600 may be connected to the first amplifier 400 and the first complementary amplifier 500, respectively, and may respectively calibrate the first amplifier 400 and the first complementary amplifier 500. The calibration may be performed periodically or may be performed when a signal-to-noise ratio is reduced.

The monitoring photodiode 600 may determine whether the first amplifier 400 and the first complementary amplifier 500 operate correctly (or not) from a change of an electrical signal passing through the first amplifier 400 and the first complementary amplifier 500. The monitoring photodiode 600 may check the performance of the first amplifier 400 and the first complementary amplifier 500 by measuring the intensity of the electrical signal passing through the first amplifier 400 and the first complementary amplifier 500.

The monitoring photodiode 600 may include a structure that provides vertical reflection or a structure that measures power through evanescent coupling in a waveguide. The monitoring photodiode 600 may have two different operation modes in order to minimize the influence on the driving of the first amplifier 400 and the first complementary amplifier 500 connected thereto and to minimize power consumption.

The optical phased array device 1001 may further include the monitoring photodiode array 700 for calibrating the light modulator 200. The monitoring photodiode array 700 may calibrate all of the plurality of channels. The monitoring photodiode array 700 may calibrate some of the plurality of channels. The monitoring photodiode array 700 may perform calibration periodically and/or when the signal-to-noise ratio is lower than a reference value.

The first level Lᵢ may include the plurality of first amplifiers 400, the plurality of first complementary amplifiers 500, and the plurality of monitoring photodiodes 600. The switch 800 of the first level Lᵢ may select the first complementary amplifier 500 to replace a first amplifier 400 when the performance of the first amplifier 400 is degraded When the first amplifier 400 is replaced with the first complementary amplifier 500, a plurality of channels associated thereafter are affected, and thus, values of the plurality of light modulators 200 may be changed. In this case, all the channels may be calibrated through the monitoring photodiode array 700 that calibrates the light modulator.

The optical phased array device 1001 may further include a second level L_{f}. The second level L_{f} may include a plurality of second amplifiers 410, a plurality of second complementary amplifiers 510 that may replace the second amplifiers 410 (e.g., with reduced performance), and the plurality of monitoring photodiodes 600.

The second amplifier 410 may amplify light modulated by the light modulator 200. The second amplifier 410 may be implemented as an FPA type and/or a TWA type. In general, a semiconductor optical amplifier may be manufactured in a small size, operates in a wavelength band of 1310 nm and 1150 nm, and is capable of bidirectional transmission, and each of the second amplifiers 410 may also have such a characteristic. Each of the plurality of second amplifiers 410 may amplify light modulated by the light modulator 200 with the same gain, but the disclosure is not limited thereto. Each of the plurality of second amplifiers 410 may amplify light modulated by the light modulator 200 with different gains.

The second complementary amplifier 510 may be configured to replace the second amplifier 410 with degraded performance. The second complementary amplifier 510 may be the same as the second amplifier 410 except that the second complementary amplifier 510 may replace the second amplifier 410 with degraded performance.

The optical phased array device 1001 may further include a second switch 801 for switching the second complementary amplifier 510 to be in or out of an optical path toward the output terminal. The second switch 801 may be ′ P′ ′ Q′ optical switch. The second switch 801 may be ′ P′ ′ Q′ optical switch that changes an optical path passing through any one o′ P′ number of second amplifiers 410 to an optical path passing through any one o′ Q′ number of second complementary amplifiers 510′ P′ means the number of second amplifiers 410, an′ Q′ means the number of second complementary amplifiers 510 to replace the second amplifier 410.

The second switch 801 of the second level L f may select the second complementary amplifier 510 to replace the second amplifier 410 when the performance of the second amplifier 410 is degraded. When the second amplifier 410 is replaced with the second complementary amplifier 510, the monitoring photodiode array 700 may calibrate a channel adjacent to the replaced second amplifier 410 among the plurality of second amplifiers 410.

For example, in at least one embodiment, 32×14 optical switch may be applied to the second level L_{f}. That is, the second switch 801 connected between 32 second amplifiers 410 and 14 second complementary amplifiers 510 may be applied to the second level L_{f}. When the 32×14 optical switch are applied to the second level L_{f}, the driving probability of the optical phased array device 1001 may be 95% or more.

An electrical contact between the light source, the switches 800, the second switch 801, the first amplifiers 400, the second amplifier 410, the first complementary amplifier 500, the second complementary amplifier 510, the light modulator 200, and/or the monitoring photodiode 600 may be implemented by packaging technology. An electrical contact between the light source, the switches 800, the second switch 801, the first amplifiers 400, the second amplifier 410, the first complementary amplifier 500, the second complementary amplifier 510, the light modulator 200, and/or the monitoring photodiode 600 may be implemented, for example, by through-silicon-via (TSV) packaging technology.

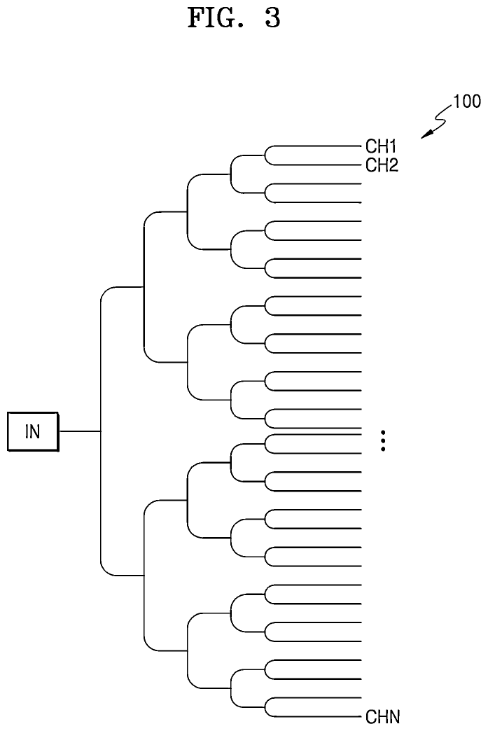

FIG. 3 is a diagram illustrating an example of a light distribution unit 100 that may be included in an optical phased array device according to at least one embodiment.

Referring to FIG. 3, the light distribution unit 100 may form 2^{M} number of optical paths in a perfect binary tree structure by branching input light M times. In distributing light, the light distribution unit 100 may use splitters that distribute light in a ratio of 1:2 by connecting the splitters in multiple stages. The light distribution unit 100 may be formed based on a waveguide, and a splitter may be disposed at each branch point. The light distribution unit 100 may include a light input unit to which light is input from a light source, and a light split unit that splits light received from the light input unit into pieces of sub-light. The light distribution unit 100 may be formed based on a multi-mode interference (MMI) form and may be configured such that optical coupling loss and optical branching loss are less than or equal to a preset (or otherwise determined) reference value.

In FIG. 3, although it is illustrated that input light passes through the light distribution unit 100, branches 5 times, and is distributed into 32 pieces of light, this is only an example and not necessarily limited thereto. For example, input light may pass through the light distribution unit 100 and branch, e.g., six times to be distributed into, e.g., 64 pieces of light.

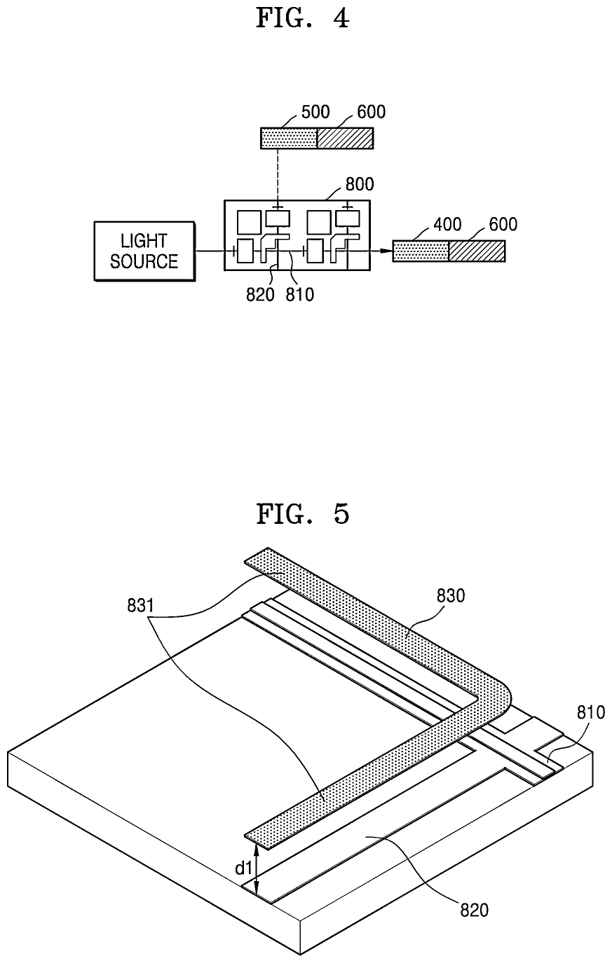

FIGS. 4 to 7 are diagrams illustrating a switch according to at least one embodiment.

Referring to FIGS. 4 and 5, the switch 800 may include an adiabatic taper 830. The adiabatic taper 830 may change a path of light. When the first amplifier 400 operates normally, light travels through the first waveguide 810 and is directed to the first amplifier 400. When the first amplifier 400 operates normally, ends 831 of the adiabatic taper 830 move to a first position that is vertically apart from the first waveguide 810 and a second waveguide 820 by at least a distance d1. The distance d1 is a length at which light energy is not substantially transmitted between the ends 831 of the adiabatic taper 830 and each of the first and second waveguides 810 and 820. Light emitted from a light source may travel toward the first amplifier 400 through the first waveguide 810 substantially without disturbance by the adiabatic taper 830.

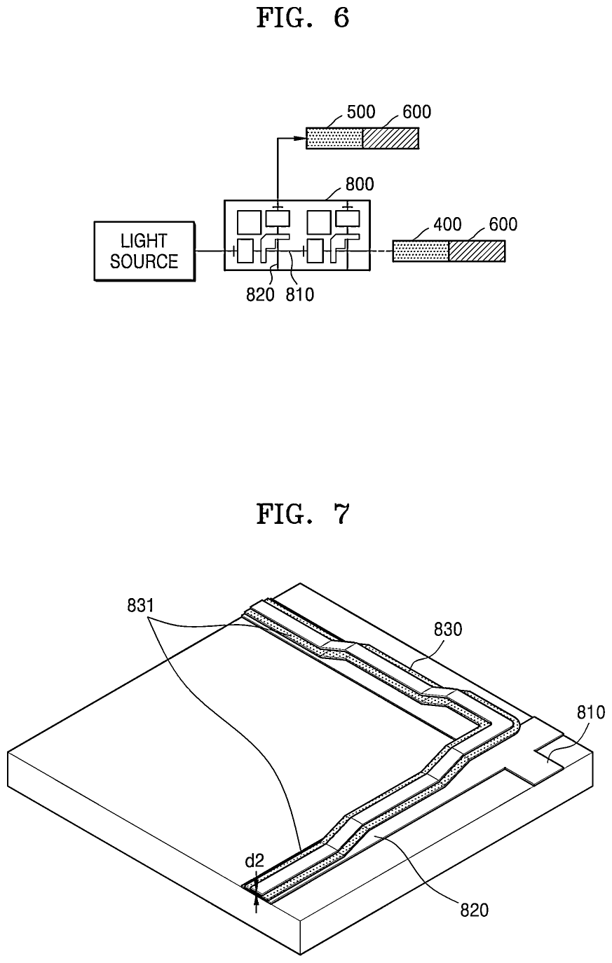

Referring to FIGS. 6 and 7, when the monitoring photodiode 600 detects the malfunction of the first amplifier 400 and attempts to replace the first amplifier 400 to the first complementary amplifier 500, light moves towards the first complementary amplifier 500 through the second waveguide 820. When the first amplifier 400 malfunctions, the end units 831 of the adiabatic taper 830 move to a second position that is vertically apart from the first waveguide 810 and the second waveguide 820 by a distance d2. The distance d2 is a length at which light energy of an optical signal is completely transmitted from the end units 831 of the adiabatic taper 830 to each of the first and second waveguides 810 and 820. The adiabatic taper 830 may move light in a vertical direction. As the end units 831 of the adiabatic taper 830 move to the second position, light may travel toward the first complementary amplifier 500 through the second waveguide 820 along the adiabatic taper 830.

The switch 800 may be at each intersection of the first waveguide 810 and the second waveguide 820. In this way, light may be arbitrarily routed by using the switch 800 including the adiabatic taper 830.

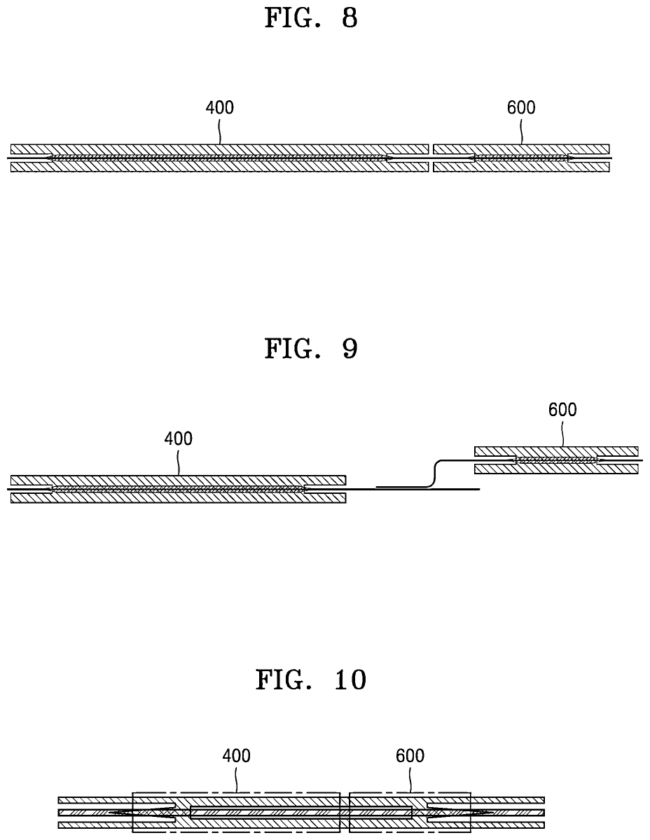

FIGS. 8 to 10 are diagrams illustrating a connection between the first amplifier 400 and the monitoring photodiode 600 according to at least one embodiment.

Referring to FIG. 8, the monitoring photodiode 600 may be serially connected to the first amplifier 400. The serial connection may denote a cascade connection.

The monitoring photodiode 600 may have two different operation modes in order to minimize the influence on the driving of the first amplifier 400 connected to the monitoring photodiode 600 and to minimize power consumption. When the monitoring photodiode 600 is serially connected to the first amplifier 400, the monitoring photodiode 600 may have a first operation mode which is a forward driving mode and a second operation mode in which power is measured through a reverse direction voltage. The first operation mode may operate when the first amplifier 400 is normally driven, and the second operation mode may operate when the first amplifier 400 is calibrated.

Referring to FIG. 9, the monitoring photodiode 600 may have a tapped connection to the first amplifier 400. The tapped connection, as a method of measuring power by extracting a portion of light by using coupling through a silicon waveguide, may denote a connection so that the monitoring photodiode 600 measures not all, but only a part of power of the first amplifier 400.

When the monitoring photodiode 600 has a tapped connection to the first amplifier 400, the monitoring photodiode 600 may measure power through a reverse direction voltage only during calibration in order to minimize the influence on the driving of the first amplifier 400 and to minimize power consumption.

Referring to FIG. 10, the monitoring photodiode 600 may have a dissected connection to the first amplifier 400. The dissected connection may denote a connection in which the entire device is driven by the first amplifier 400 during normal driving, and some sections of the first amplifiers 400 act as monitoring photodiodes 600 by applying a reverse direction bias to the optical phased array devices 1000 only during calibration.

The monitoring photodiode 600 may have two different operation modes in order to minimize the influence on the driving of the connected first amplifier 400 and to minimize power consumption. When the monitoring photodiode 600 has a dissected connection to the first amplifier 400, the monitoring photodiode 600 may include a first operation mode which is a forward driving mode and a second operation mode in which power is measured through a reverse direction voltage. The first operation mode may operate when the first amplifier 400 is normally driven, and the second operation mode may operate when the first amplifier 400 is calibrated.

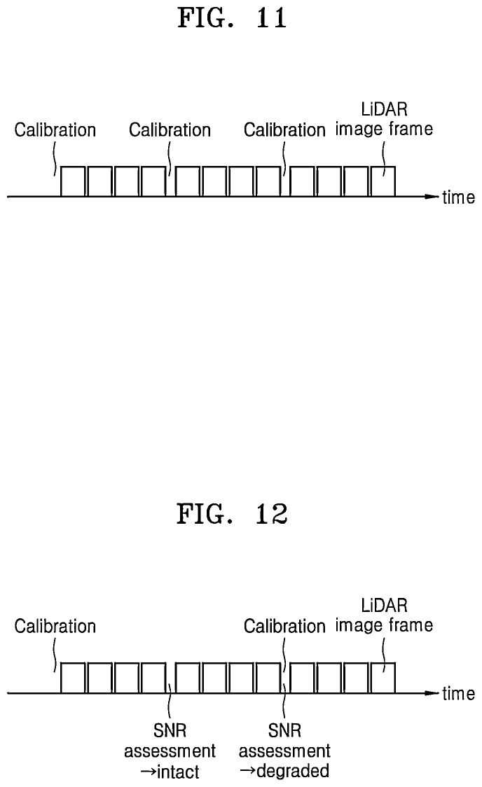

FIG. 11 is a timing diagram illustrating a periodic calibration method.

As shown in FIG. 11, a monitoring photodiode and a monitoring photodiode array may perform a calibration at the beginning of the operation of the optical phased array device, and thereafter, the calibration may be periodically performed whenever a light steering operation of one frame is completed.

FIG. 12 is a timing diagram illustrating a calibration method based on a signal-to-noise ratio.

As shown in FIG. 12, a monitoring photodiode and a monitoring photodiode array may perform a calibration at the beginning of the operation of the optical phased array device, and then calibration is not performed while a signal-to-noise ratio is normal, and calibration is performed only when the signal-to-noise ratio is lower than a reference value.

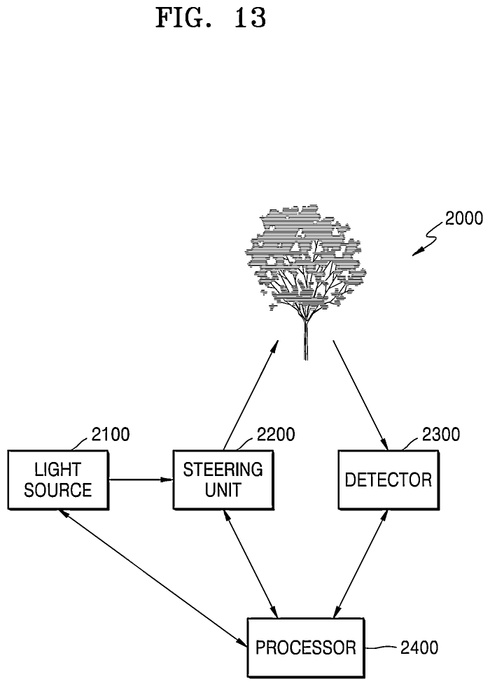

FIG. 13 is a diagram illustrating a LiDAR device 2000 according to at least one embodiment.

As shown in FIG. 13, the LiDAR device 2000 includes a light source 2100 configured to generate light, a steering unit 2200 configured to steer light output from the light source 2100 toward an object, a detector 2300 configured to detect light reflected by the object, and a processor 2400 configured to perform an operation for obtaining information about the object from the light detected by the detector 2300 and/or to perform operations based on the obtained information. The LiDAR device 2000 may further include a plurality of waveguides that provide optical connections between the light source 2100 and the steering unit 2200 and/or between the steering unit 2200 and the detector 2300, respectively. The light source 2100, the steering unit 2200, the detector 2300, and the processor 2400 may be implemented as separate devices or as a single device.

The light source 2100 may be a tunable laser configured to adjust the wavelength of emitted light. A plurality of laser beams may be emitted from the light source 2100, and laser beams having optical coherence among the plurality of laser beams may be incident on the steering unit 2200. The light source 2100 may generate and output light of different wavelength bands. In addition, the light source 2100 may generate and output pulsed light and/or continuous light.

The light source 2100 may include a laser diode (LD), an edge emitting laser, a vertical-cavity surface emitting laser (VCSEL), a distributed feedback laser, and a light-emitting diode (LED), a super luminescent diode (SLD), etc.

The light source 2100 may be directly coupled to the waveguide (on-chip) or indirectly coupled (off-chip) to the waveguide. For example, the on-chip light source may be implemented through III-V bonding or epitaxial growth; and/or the off-chip light source may be implemented by vertical coupling, edge coupling, chip alignment, and/or the like of an external light source.

The steering unit 2200 may include an optical phased array device that illuminates an object by changing a traveling direction of light from the light source 2100 and may control a direction of light without a mechanical movement. The optical phased array device may be the same as the optical phased array devices 1000 and 1001 of FIGS. 1 and 2. The steering unit 2200 may transmit amplified light toward a local region in front in a one-dimensional (1D) or two-dimensional (2D) scanning method. To this end, the steering unit 2200 may sequentially or non-sequentially steer light focused on a narrow region to front 1D or 2D regions at regular time intervals. For example, the steering unit 2200 may be configured to emit laser light from bottom to top or from top to bottom for 1D regions in front. Furthermore, the steering unit 2200 may be configured to emit laser light from left to right or from right to left for the front 1D regions.

The detector 2300 may detect light reflected by an object and may generate an electrical signal based on the detected light. The detector 2300 may include an array of light detection elements. The detector 2300 may further include a spectrometer for analyzing light reflected from an object for each wavelength.

The processor 2400 may perform an operation for obtaining information about an object from the light detected by the detector 2300. In addition, the processor 2400 may oversee processing and control of the LiDAR device 2000 entirely. The processor 2400 may acquire and process information about an object. For example, the processor 2400 may acquire and process 2D or 3D image information. The processor 2400 may generally control the driving of the light source 2100 and the steering unit 2200 or the operation of the detector 2300. For example, the processor 2400 may control an electrical signal applied to the optical phased array device included in the steering unit 2200. The processor 2400 may also analyze a distance between a target object and the LiDAR device 2000 and the shape of the target object through numerical information provided by the detector 2300.

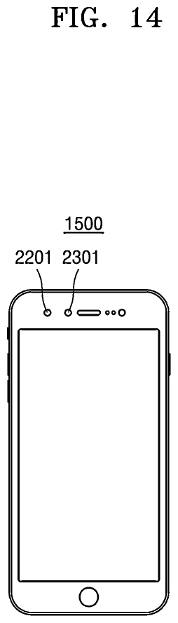

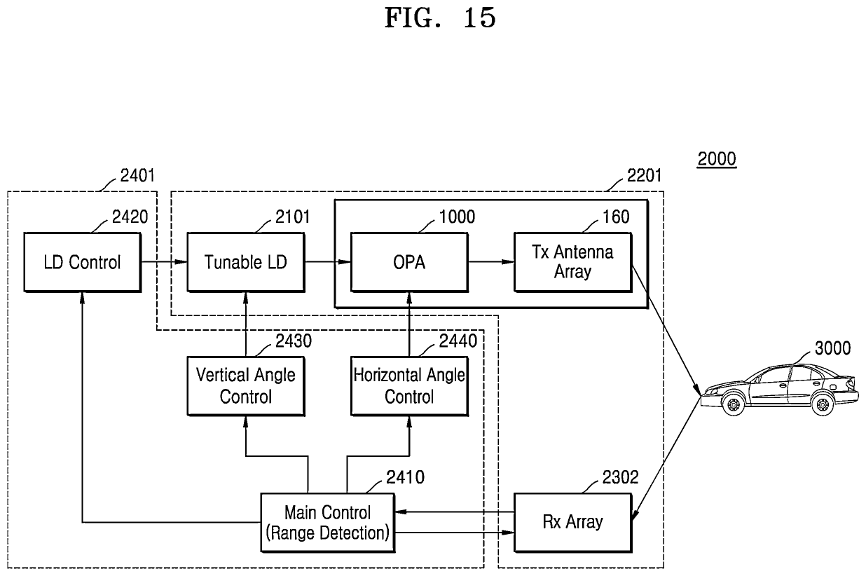

In at least one embodiment, a 3D image obtained by the processor 2400 may be transmitted to another unit and utilized. For example, such information may be transmitted to the processor 2400 of an autonomous driving device, such as a vehicle or a drone in which the LiDAR device 2000 is employed. Besides the above, such information may be utilized in smartphones, mobile phones, personal digital assistants (PDAs), laptops, personal computers (PCs), wearable devices, and other mobile or non-mobile computing devices. For example, FIGS. 14 and 15 are example semiconductor systems to which the optical beam steering device and the sensor system according to some example embodiments of the present disclosure can be applied. The example semiconductor system illustrated in FIG. 14 is included in a smartphone, which may extract depth information of objects in an image, control out-focusing of an image, or automatically identify objects in an image by using the LiDAR device 2000 that is an object 3D sensor.

Referring to FIG. 14, the smartphone 1500 may include the steering unit 2201 and the detector 2301. The smartphone 1500 irradiates a user with laser beam using the steering unit 2201, and the detector 2301 receives the laser beam reflected from the user, thereby scanning the user.

In addition, the LiDAR device 2000 according to at least one embodiment may be applied to a vehicle. The vehicle may include a plurality of LiDAR devices 2000 disposed in various locations. The vehicle may provide the driver with various pieces of information about the interior or the surroundings of the vehicle by using the LiDAR device 2000, and may provide information necessary for autonomous driving by automatically recognizing objects or people in the image. For example, referring to FIG. 15 the LiDAR device 2000 according to some example embodiments may include the OPA 1000, the light source 2101, the detector 2302, and a processor 2401. As shown in FIG. 15, in some example embodiments, one or more LiDAR devices 2000 may be included in one or more portions of a vehicle 3000. The vehicle 3000 may include a vehicle that is configured to be driven (“navigated”) manually (e.g., based on manual interaction with one or more driving instruments of the vehicle 3000 by at least one occupant of the vehicle 3000), a vehicle that is configured to be driven (“navigated”) autonomously (e.g., an autonomous vehicle configured to be driven based on at least partial computer system control of the vehicle 3000 with or without input from vehicle 3000 occupant(s)), some combination thereof, and/or the like. For example, in some example embodiments, the vehicle 3000 may be configured to be driven (“navigated”) through an environment based on generation of data by one or more LiDAR devices 2000 included in the vehicle 3000. Such navigation may include the vehicle 3000 being configured to navigate through an environment, in relation to an object located in the environment, based on data generated by the LiDAR device as a result of the LiDAR device emitting a laser beam into the environment and detecting the object in the environment, where the LiDAR device may detect the object based on detecting a reflection and/or scattering of the emitted laser beam off of the object.

The OPA 1000 has been described with reference to FIG. 1. In at least one embodiment, the outputs of the OPA 1000 may be connected to (and/or included in) a transmission antenna array 160. In at least one embodiment, the transmission antenna array 160 may be configured to, for example, uniformly direct the output light.

The detector 2302 may include a photodiode. In the LiDAR device 2000 according to some example embodiments, the detector 2302 may be formed so as to include a plurality of photodiodes arranged as an array structure. In order to emphasize the array structure of the detector 2302, ‘Rx array’ is used to indicate the detector 2302 in FIG. 15. Similarly, the antenna 160 may also be formed such that a plurality of unit antennas are arranged in an array. Accordingly, ‘Tx Antenna Array’ is used to indicate the antenna 160 in FIG. 15.

The processor 2401 may include an LD controller 2420, a vertical angle controller 2430, a horizontal angle controller 2440, and a main controller 2410. The LD controller 2420 controls light output from the light source 2101. For example, the LD controller 2420 may control a power supply to the light source 2101, switching on/off of the light source 2101, and the generation of Pulse Waves (PWs) or Continuous Waves (CWs) of the light source 2101.

In at least example, the vertical angle controller 2430 may control a vertical angle of an optical signal output from the antenna 160 by adjusting a wavelength or a frequency of output light from the light source 2101. The horizontal angle controller 2440 may control a horizontal angle of an optical signal output from the antenna 160 by adjusting the OPA 1000. When the OPA 1000 is adjusted, it may mean that a phase of an optical signal is adjusted by adjusting a physical quantity. In this case, when a phase of an optical signal is shifted, a direction in which the optical signal is output from the antenna 160, for example, a horizontal angle of the optical signal, may be changed.

The main controller 2410 may control overall operations of the LD controller 2420, the vertical angle controller 2430, the horizontal angle controller 2440, and the detector 2302. Also, the main controller 2410 may receive information about an optical signal reflected from the detector 2302 and may calculate a distance to an object. For example, the main controller 2410 may calculate a distance to an object by using a time of flight (TOF) technology.

The TOF technology is a technology for measuring a distance to an object by using a signal such as near-infrared rays, ultrasonic waves, or a laser. In detail, the TOF technology calculates a distance by measuring a time difference between when a signal is emitted to an object and when the signal is reflected from the object. In the TOF technology, since a transmitter applies a signal and a receiver receives a signal reflected from an object to measure a travel time of the signal, the transmitter and the receiver may be slightly spaced apart from each other in one device. Also, since the signal from the transmitter may affect the receiver, a shielding film may be between the transmitter and the receiver.

The transmitter sends an optical signal modulated at a specific frequency f, and the receiver detects an optical signal reflected from an object. A phase change due to a time taken for the optical signal to travel to and from the object may be detected, and a distance to the object may be calculated as shown in Equation 1.

D=c/(2f)*(n+θ/(2π) (1)

In Equation 1, D may be a distance of measurement, c may be a speed of light, f may be a frequency of an optical signal, n may be a constant when a phase cycle is repeated, and θ may be a phase of the received optical signal.

When a maximum value of the distance of measurement D is determined and the constant n is assumed to be 0, the distance of measurement D may be defined by using Equation 2.

D=cθ/(4πf) (2)

In the LiDAR device 2000 according to at least example embodiment, the OPA 1000, the light source 2101, and the detector 2302 may be integrated together in a bulk-silicon substrate.

Because an optical phased array device including a complementary amplifier according to at least one embodiment and a LiDAR device including the optical phased array device includes a complementary amplifier, even if the number of channels increases, the driving probability may be increased.

According to at least one embodiment, an optical phased array device including a complementary amplifier and a LiDAR device including the same may increase the driving probability even if the number of channels is increased through extra amplifiers.

An optical phased array device including a complementary amplifier, and a LiDAR device including the same have been described with reference to the embodiment shown in the drawings. However, it will be understood by those of ordinary skill in the art that various changes in form and details may be made therein without departing from the spirit and scope of the inventive concepts. Therefore, the embodiments should be considered in descriptive sense only and not for purposes of limitation. The scope of the inventive concepts is defined not by the detailed description of the inventive concepts but by the appended claims, and all differences within the scope will be construed as being included in the inventive concepts.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope as defined by the following claims.

What is claimed is:

1. An optical phased array device comprising:
a light distribution unit configured to branch a traveling path of light, input through an input terminal, at least twice, and to direct distributed pieces of sub-light to a plurality of output terminals;
at least one light modulator configured to form a plurality of channels by modulating phases of the pieces of sub-light;
at least one first amplifier in an optical path between the input terminal and the at least one light modulator, the at least one first amplifier configured to amplify at least a piece of sub-light;
at least one first complementary amplifier configured to replace the at least one first amplifier; and
a switch configured to switch the first complementary amplifier in or out of the optical path between the input and the at least one light modulator.

2. The optical phased array device of claim 1, wherein the light distribution unit includes a plurality of branch points, and
wherein the at least one first amplifier is disposed in each of a plurality of optical paths between an initial branch point and a final branch point.

3. The optical phased array device of claim 2, wherein the at least one light modulator is disposed in each of a plurality of optical paths between the final branch point and the plurality of output terminals.

4. The optical phased array device of claim 2, wherein the light distribution unit is configured to branch the light input through the input terminal M times to form 2^{M} number of optical paths.

5. The optical phased array device of claim 2, wherein the number of first amplifiers is P, and the number of first complementary amplifiers is Q,
wherein the switch is a P×Q optical switch configured to change an optical path passing through at least one of the first amplifiers to an optical path passing through at least one of the first complementary amplifiers.

6. The optical phased array device of claim 1, further comprising:
a monitoring photodiode electrically connected to the at least one first amplifier and configured to monitor the performance of the at least one first amplifier.

7. The optical phased array device of claim 6, wherein the monitoring photodiode is connected in serial or dissected with the at least one first amplifier.

8. The optical phased array device of claim 7, wherein the monitoring photodiode is configured to include a first operating mode, in which power is through a forward direction voltage, and a second operation mode in which power is measured through a reverse direction voltage.

9. The optical phased array device of claim 6, wherein the monitoring photodiode has a tapped connection with the at least one first amplifier.

10. The optical phased array device of claim 9, wherein the monitoring photodiode measures power via a reverse direction voltage only during calibration.

11. The optical phased array device of claim 1, further comprising:
a monitoring photodiode array for calibrating the at least one light modulator.

12. The optical phased array device of claim 11, wherein the monitoring photodiode array is configured to monitor all of the plurality of channels.

13. The optical phased array device of claim 1, wherein the optical phase array device is configured such that the switch replaces the at least one first amplifier with the at least one first complementary amplifier when the performance of the at least one first amplifier is degraded.

14. The optical phased array device of claim 1, further comprising:
at least one second amplifier in an optical path passing through the at least one light modulator;
at least one second complementary amplifier configured to replace the at least one second amplifier; and
a second switch configured to switch the at least one second complementary amplifier in and out of the optical path passing through the at least one light modulator.

15. The optical phased array device of claim 14, wherein the optical phased array device is configured such that the second switch replaces the at least one second amplifier with the at least one second complementary amplified when the performance of the at least one second amplifier is degraded.

16. The optical phased array device of claim 14, wherein the number of second amplifiers is P′, and
the number of second complementary amplifiers is Q′,
wherein the second switch comprises a P′×Q′ optical switch configured to change an optical path passing through at least one of the P′ number of second amplifiers to an optical path passing through at least one of the Q′ number of second auxiliary amplifiers.

17. The optical phased array device of claim 16, further comprising:
a monitoring photodiode array for calibrating the light modulator.

18. The optical phased array device of claim 17, wherein the monitoring photodiode array is for calibrating a channel adjacent to the replaced second amplifier among a plurality of second amplifiers.

19. The optical phased array device of claim 1, further comprising:
a waveguide-based structure forming an optical connection between the light distribution unit, the at least one first amplifier, the first complementary amplifier, and the switch.

20. A light detection and ranging (LiDAR) device comprising:
a light source;
a detector;
a processor; and
a steering unit including an optical phased array device including
a light distribution unit configured to branch a traveling path of light, input through an input terminal, at least twice, and to direct distributed pieces of sub-light to a plurality of output terminals,
at least one light modulator configured to form a plurality of channels by modulating phases of the pieces of sub-light,
at least one first amplifier in an optical path between the input terminal and the at least one light modulator, the at least one first amplifier configured to amplify at least a piece of sub-light
at least one first complementary amplifier configured to replace the at least one first amplifier, and
a switch configured to switch the at least one first complementary amplifier in or out of the optical path between the input and the at least one light modulator.
